(19) United States
(12) Patent Application Publication
(10) Pub. No.: US 2025/0045971 A1
(43) Pub. Date: Feb. 6, 2025

(54) HYBRID FRAMEWORK FOR POINT CLOUD COMPRESSION

(71) Applicant: InterDigital VC Holdings, Inc., Wilmington (DE)

(72) Inventors: Jiahao PANG, New York, NY (US); Muhammad Asad LODHI, New York, NY (US); Dong TIAN, New York, NY (US)

(21) Appl. No.: 18/719,247

(22) PCT Filed: Oct. 18, 2022
(86) PCT No.: PCT/US2022/046950

§ 371 Date: Jun. 12, 2024

Related U.S. Application Data
(60) Provisional application No. 63/291,015, filed on Dec. 17, 2021.

(51) Int. Cl. G06T 9/00

(52) U.S. Cl. CPC G06T 9/001; G06T 9/002

(57) ABSTRACT

In one implementation, we propose a hybrid architecture to compress and decompress a point cloud. In particular, a first decoding block is for the most significant bits, typically coded by a tree-based coding method. A second decoding block is for the middle-range of bits, typically coded by a voxel-based method. A third decoding block is for the least significant bits, typically coded by a point-based method. For example, the decoder configures the decoder's network according to the total number of bits and the bit partitioning positions; decodes a coarse point cloud and its associated point-wise features using a tree-based decoding block; upsamples the coarse point cloud to a denser one and updates the point-wise features using a voxel-based decoding block; and refines the precision of the coordinates of the dense but low bit depth point cloud to high bit depth point cloud using a point-based decoding block.

### TECHNICAL FIELD

The present embodiments generally relate to a method and an apparatus for point cloud compression and processing.

### BACKGROUND

The Point Cloud (PC) data format is a universal data format across several business domains, e.g., from autonomous driving, robotics, augmented reality/virtual reality (AR/VR), civil engineering, computer graphics, to the animation/movie industry. 3D LiDAR (Light Detection and Ranging) sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever and is expected to be an ultimate enabler in the applications discussed herein.

### SUMMARY

According to an embodiment, a method of decoding point cloud data for a point cloud is provided, comprising: decoding a first set of data using a first decoding strategy, wherein said first set of data corresponds to a first subset of bit levels of said point cloud data; and decoding a second set of data using a second decoding strategy, wherein said second set of data corresponds to a second subset of bit levels of said point cloud data. The method can further comprise decoding a third set of data using a third decoding strategy, wherein said third set of data corresponds to a third subset of bit levels of said point cloud data.

According to another embodiment, a method of encoding point cloud data for a point cloud is provided, comprising: encoding a first set of data using a first encoding strategy, wherein said first set of data corresponds to a first subset of bit levels of said point cloud data; and encoding a second set of data using a second encoding strategy, wherein said second set of data corresponds to a second subset of bit levels of said point cloud data. The method can further comprise encoding a third subset of data using a third encoding strategy, wherein said third subset of data corresponds to a third subset of bit levels of said point cloud data.

According to another embodiment, an apparatus for decoding point cloud data for a point cloud is provided, comprising one or more processors, wherein said one or more processors are configured to: decode a first set of data using a first decoding strategy, wherein said first set of data corresponds to a first subset of bit levels of said point cloud data; and decode a second set of data using a second decoding strategy, wherein said second set of data corresponds to a second subset of bit levels of said point cloud data. The apparatus can be further configured to decode a third set of data using a third decoding strategy, wherein said third set of data corresponds to a third subset of bit levels of said point cloud data.

According to another embodiment, an apparatus for encoding point cloud data for a point cloud is provided, comprising one or more processors, wherein said one or more processors are configured to: encode a first set of data using a first encoding strategy, wherein said first set of data corresponds to a first subset of bit levels of said point cloud data; and encode a second set of data using a second encoding strategy, wherein said second set of data corresponds to a second subset of bit levels of said point cloud data. The apparatus can be further configured to encode a third subset of data using a third encoding strategy, wherein said third subset of data corresponds to a third subset of bit levels of said point cloud data.

One or more embodiments also provide a computer program comprising instructions which when executed by one or more processors cause the one or more processors to perform the encoding method or decoding method according to any of the embodiments described above. One or more of the present embodiments also provide a computer readable storage medium having stored thereon instructions for encoding or decoding point cloud data according to the methods described above.

One or more embodiments also provide a computer readable storage medium having stored thereon video data generated according to the methods described above. One or more embodiments also provide a method and apparatus for transmitting or receiving the video data generated according to the methods described above.

### BRIEF DESCRIPTION OF THE DRAWINGS

FIG. 1 illustrates a block diagram of a system within which aspects of the present embodiments may be implemented.

FIGS. 2A, 2B, 2C and 2D illustrate point-based, octree-based, voxel-based, and sparse voxel-based point cloud representations, respectively.

FIG. 3 illustrates a bit level example.

FIG. 4 illustrates an encoding diagram, according to an embodiment.

FIG. 5 illustrates a PN block, according to an embodiment.

FIG. 6 illustrates a VN block, according to an embodiment.

FIG. 7 illustrates an ON block, according to an embodiment.

FIG. 8 illustrates a decoding diagram, according to an embodiment.

FIG. 9 illustrates an ON* block, according to an embodiment.

FIG. 10 illustrates a VN* block, according to an embodiment.

FIG. 11 illustrates a PN* block, according to an embodiment.

FIG. 12 illustrates an encoding diagram, according to another embodiment.

FIG. 13 illustrates a decoding diagram, according to another embodiment.

FIG. 14 illustrates a method of encoding point cloud data, according to an embodiment.

FIG. 15 illustrates a method of decoding point cloud data, according to an embodiment.

### DETAILED DESCRIPTION

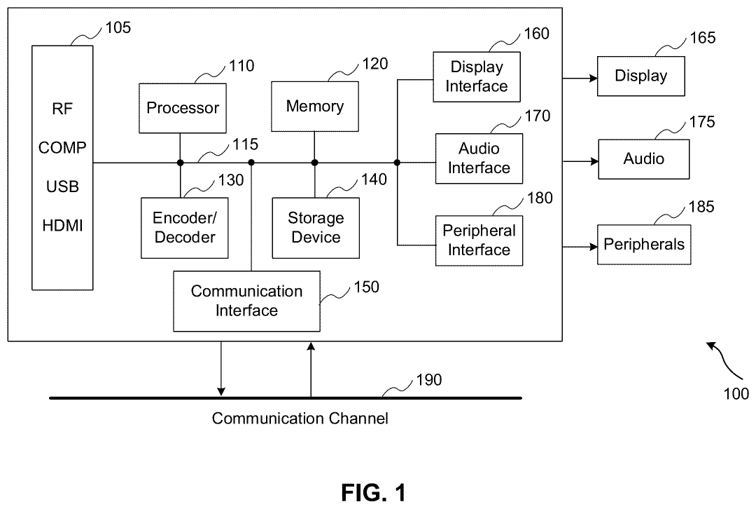

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, JPEG Pleno, MPEG-I, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

It is contemplated that point cloud data may consume a large portion of network traffic, e.g., among connected cars over 5G network, and immersive communications (VR/AR). Efficient representation formats are necessary for point cloud understanding and communication. In particular, raw point cloud data need to be properly organized and processed for the purposes of world modeling and sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be in real-time or with low delay.

3D point cloud is composed of a set of 3D points. Each point is defined by its 3D position (x,y,z). A 3D point cloud then represents the geometry shape of an object or a scene. Optionally, each point could be further associated with some attributes, for example, RGB color (r,g,b), normal (nx,ny,nz), and/or reflectance (r), depending on applications. In this work, we mainly focus on the processing and compression of the point cloud geometry.

The automotive industry and autonomous car are domains in which point clouds may be used. Autonomous cars should be able to “probe” their environment to make good driving decisions based on the reality of their immediate surroundings. Typical sensors like LiDARs produce (dynamic) point clouds that are used by the perception engine. These point clouds are not intended to be viewed by human eyes and they are typically sparse, not necessarily colored, and dynamic with a high frequency of capture. They may have other attributes like the reflectance ratio provided by the LiDAR as this attribute is indicative of the material of the sensed object and may help in making a decision.

Virtual Reality (VR) and immersive worlds are foreseen by many as the future of 2D flat video. For VR and immersive worlds, a viewer is immersed in an environment all around the viewer, as opposed to standard TV where the viewer can only look at the virtual world in front of the viewer. There are several gradations in the immersivity depending on the freedom of the viewer in the environment. Point cloud is a good format candidate to distribute VR worlds. The point cloud for use in VR may be static or dynamic and are typically of average size, for example, no more than millions of points at a time.

Point clouds may also be used for various purposes such as culture heritage/buildings in which objects like statues or buildings are scanned in 3D in order to share the spatial configuration of the object without sending or visiting the object. Also, point clouds may also be used to ensure preservation of the knowledge of the object in case the object may be destroyed, for instance, a temple by an earthquake. Such point clouds are typically static, colored, and huge.

Another use case is in topography and cartography in which using 3D representations, maps are not limited to the plane and may include the relief. Google Maps is a good example of 3D maps but uses meshes instead of point clouds. Nevertheless, point clouds may be a suitable data format for 3D maps and such point clouds are typically static, colored, and huge.

World modeling and sensing via point clouds could be a useful technology to allow machines to gain knowledge about the 3D world around them for the applications discussed herein.

3D point cloud data are essentially discrete samples on the surfaces of objects or scenes. To fully represent the real world with point samples, in practice it requires a huge number of points. For instance, a typical VR immersive scene contains millions of points, while point clouds typically contain hundreds of millions of points. Therefore, the processing of such large-scale point clouds is computationally expensive, especially for consumer devices, e.g., smartphone, tablet, and automotive navigation system, that have limited computational power.

In order to perform processing or inference on a point cloud, efficient storage methodologies are needed. To store and process an input point cloud with affordable computational cost, one solution is to down-sample the point cloud first, where the down-sampled point cloud summarizes the geometry of the input point cloud while having much fewer points. The down-sampled point cloud is then fed to the subsequent machine task for further consumption. However, further reduction in storage space can be achieved by converting the raw point cloud data (original or downsampled) into a bitstream through entropy coding techniques for lossless compression. Better entropy models result in a smaller bitstream and hence more efficient compression. Additionally, the entropy models can also be paired with downstream tasks which allow the entropy encoder to maintain the task-specific information while compressing.

In addition to lossless coding, many scenarios seek lossy coding for significantly improved compression ratio while maintaining the induced distortion under certain quality levels.

### Point Cloud Representations

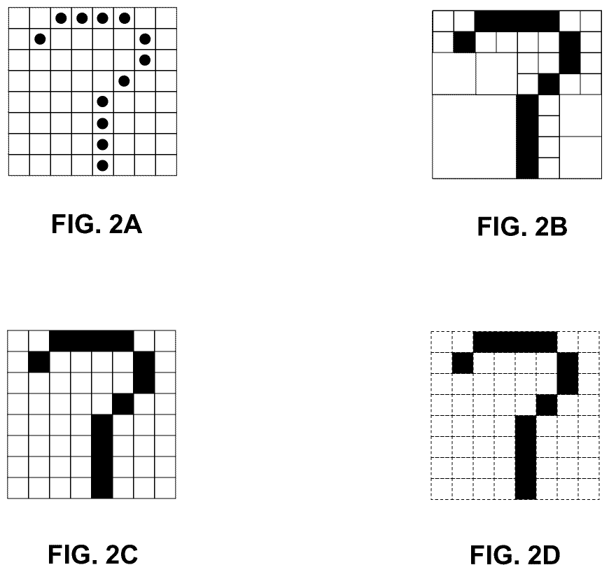

Learning-based point cloud compression has been emerging recently. Existing methods can be mainly classified into three categories depending on the point cloud representation format: point-based, voxel-based and octree-based, as shown in FIGS. 2A, 2B, 2C and 2D.

### Point-Based Representation

In a native point-based representation as illustrated in FIG. 2A, a point is directly specified by its coordinates in 3D and no point size is defined.

### Octree-Based Representation

In an octree-based representation as illustrated in FIG. 2B, the whole space, i.e., a 3D bounding box, is recursively split into an octree structure to represent a point cloud. If the bounding box has a scale of 1×1×1, an octree leaf node corresponds to a point with a size equal to 1/(2^{d})×1/(2^{d})×1/(2^{d}), where index d represents the depth level in the octree counted from 0.

In an octree decomposition tree, the root node covers the whole 3D bounding box. The 3D space is equally split in every direction, i.e., x-, y-, and z-directions, leading to eight (8) voxels. For each voxel, if there are at least one point in it, the voxel is marked to be occupied, represented by ‘1’; otherwise, it is marked to be empty, represented by ‘0’. The octree root node is then described by an 8-bit integer number indicating the occupancy information.

To move from an octree level to the next, the space of each occupied voxel is further split into eight (8) child voxels in the same manner. If occupied, each child voxel is further represented by an 8-bit integer number. The splitting of occupied voxels continues until the last octree depth level is reached. The leaves of the octree finally represent the point cloud.

An octree-based point cloud compression algorithm targets to code the octree node using an entropy coder. For efficient entropy coding of the octree nodes, a probability distribution model is typically utilized to allocate a shorter symbol for octree node value which appears with higher probability. A decoder could reconstruct the point cloud from the decoded octree nodes.

### Voxel-Based Representation

In a voxel-based representation as illustrated in FIG. 2C, the 3D point coordinates are uniformly quantized by a quantization step. Each point corresponds to an occupied voxel with a size equal to the quantization step.

Naïve voxel representation may not be efficient in memory usage due to large empty spaces. Sparse voxel representations are then introduced where the occupied voxels are arranged in a sparse tensor format for efficient storage and processing. Example of a sparse voxel representation is depicted in FIG. 2D where the empty voxels do not consume any memory or storage.

Note that even with sparse voxel representation, voxels are arranged in an organized manner.

Conventionally, there are three major categories of representations for point clouds. Each category of point cloud representations has specific encoding/decoding backbones, and it is not well explored how to integrate different processing backbones into a unified processing or coding framework.

In the follows, we review some prior works in handling point cloud compression according to the point cloud representation used.

### Octree-based Point Cloud Compression

Deep entropy models refer to a category of learning-based approaches that attempt to formulate a context model using a neural network module to predict the probability distribution of the node occupancy value.

One deep entropy model is known as OctSqueeze, as described in an article by Huang, Lila, et al., entitled “OctSqueeze: Octree-Structured Entropy Model for LiDAR Compression,” Proceedings of the IEEE/CVF Conference on Computer Vision and Pattern Recognition, 2020. It utilizes ancestor nodes including a parent node, a grandparent node, etc., in a hierarchical manner. Three MLP-based (Multi-Layer Perceptron) neural network modules are in use. A first MLP module takes the context of a current node as input to generate an output feature. A second MLP module takes the outputted feature of two such first MLP modules, one of which operates in the current octree depth level and the other in the previous octree depth level. The second MLP module also generates an output feature. A last third MLP module takes the outputted feature of two such second MLP modules, one from the current octree depth level and the other from the previous octree depth level. Finally, the third MLP module generates a predicted probability distribution. The estimated probability distribution is used for an efficient arithmetic coding.

Another deep entropy model is known as VoxelContextNet, as described in an article by Que, Zizheng, et al., entitled “VoxelContext-Net: An Octree based Framework for Point Cloud Compression,” In Proceedings of the IEEE/CVF Conference on Computer Vision and Pattern Recognition, pp. 6042-6051, 2021. Different from OctSqueeze that uses ancestor nodes, VoxelContextNet employs an approach using spatial neighboring voxels to first analyze the local surface shape then predict the probability distribution.

In our previous work, we proposed a self-supervised compression model that consists of an adaptive entropy coder, which operates on a tree-structured conditional entropy model. The information from the local neighborhood as well as the global topology is utilized from the octree structure.

### Voxel-Based Point Cloud Compression

Considering that 2D convolutions have been successfully employed in learning-based image compression (see an article by Ballé, Johannes, et al., entitled “Variational Image Compression with a Scale Hyperprior,” arXiv preprint arXiv: 1802.01436 (2018)), 3D convolutions have been studied for point cloud compression. For this purpose, point clouds need to be represented by voxels.

With regular 3D convolutions, a 3D kernel is overlaid on every location specified by a stride step no matter whether the voxels are occupied or empty, as described in an article by Wang, Jianqiang, et al., entitled “Learned Point Cloud Geometry Compression,” arXiv preprint arXiv: 1909.12037 (2019). To avoid computation and memory consumption by empty voxels, sparse convolutions may be applied and point cloud voxels are represented by a sparse tensor, as described in an article by Wang, Jianqiang, et al., entitled “Multiscale Point Cloud Geometry Compression,” 2021 Data Compression Conference (DCC), pp. 73-82. IEEE, 2021 (hereinafter “Wang”).

However, even with sparse convolutions accompanied by sparse tensors, it is typically inefficient to apply a large convolution kernel. This is because the representation of a convolution kernel is still a dense tensor, and many more kernel parameters can be mapped to empty voxels when kernel size is increasing. This fact leads to an inefficient training or even causes the training to fail. In Wang, the kernel size employed in sparse convolutions is only 3×3×3. Too small kernel size would lead to small receptive field and further result in less representative latent descriptors.

### Point-Based Point Cloud Compression

Learning-based point cloud compression has also been studied with the native point cloud representation. Point based architectures such as multi-layer perceptrons (MLPs) are utilized in such frameworks, for example, as described in an article by Yan, Wei, et al., entitled “Deep Autoencoder-Based Lossy Geometry Compression for Point Cloud,” arXiv preprint arXiv: 1905.03691 (2019), hereinafter “Yan” and an article by Gao, Linyao, et al., entitled “Point Cloud Geometry Compression Via Neural Graph Sampling,” In 2021 IEEE International Conference on Image Processing (ICIP), pp. 3373-3377, IEEE, 2021, hereinafter “Gao”.

In Yan, the encoder employs a 5-layer PointNet module based on MLPs to extract a feature vector for a subsampled set of point clouds. Its decoder employs a LatentGAN module based on MLPs to reconstruct the point cloud. Due to the design of LatentGAN, the size of the reconstructed point cloud cannot be adjusted without updating the dimension of the last layer of the LatentGAN.

During encoding as described in Gao, two downsampling modules are first deployed using an approach named as neural graph sampling (NGS) using point-based convolutions. Then a PointNet-like module is applied to extract a feature vector to be entropy coded.

Though point-based architectures (MLPs) could be more efficient from training perspective, the existing point-based architectures show limited compression performance for point clouds comparing to voxel-based or sparse convolution-based architectures.

In this work, we propose a hybrid coding framework that intends to fully take advantage of different types of point cloud compression approaches. Each type of approach targets to deal with certain bit levels of the point coordinates.

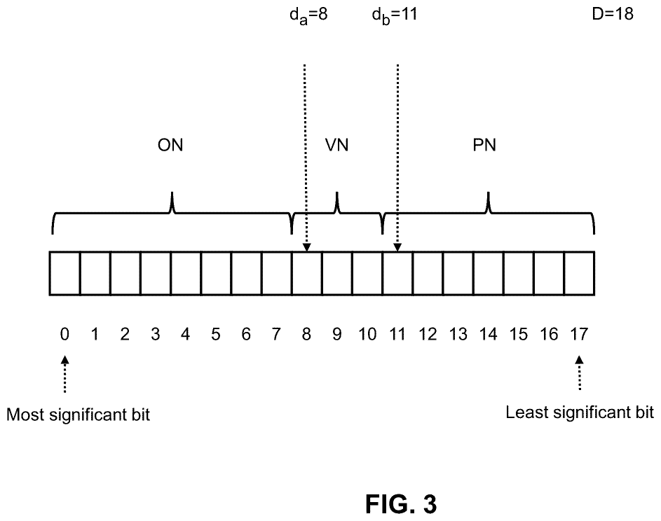

Considering a point cloud with a high bit depth, i.e., D-bits, we propose to use different coding strategies for different bit levels. Let index d represents the bit level or the corresponding depth level of the octree decomposition. For the most significant bit or root level, we have d=0. FIG. 3 shows an illustration of how the bits of a coordinate number with D=18 bits are indexed in this work.

We propose the following hybrid coding framework: for the first few bits, i.e., d=0, . . . , dₐ-1, a tree-based coding strategy, e.g., an octree-based coding method, is used. There is no need to do downsampling or abstractions. For the next few bits, i.e., d=dₐ, . . . , d_{b}−1, there is a good number of occupied voxels and the voxels are typically connected to each other. Hence, a voxel-based coding strategy, e.g., a regular or sparse convolution, is used. For the last few bits, i.e., d=d_{b}, . . . , D−1, the points are very sparse, regular convolution or sparse convolution would fail due to a lack of reasonable neighboring voxels or points. As a result, a point-based coding strategy, e.g., with multi-layer perceptron (MLP), is used. In the follows, we elaborate the proposed hybrid encoding and decoding process.

### Encoding

On the encoder side, the bit level parameters (dₐ, d_{b}) are determined depending on the characteristics of input point clouds. The selected bit level parameter (dₐ, d_{b}) and the total bit depth D need to be known to the decoder, e.g., transmitted via a sequence parameter set, a picture parameter set, or a supplementary enhancement information (SEI) message.

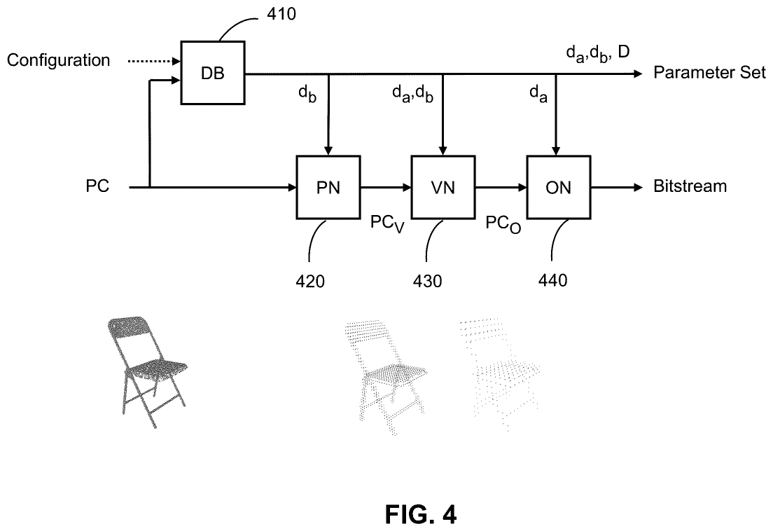

FIG. 4 shows a block diagram that implements the proposed encoding procedure, according to an embodiment. In particular, the “DB” block (410) determines the parameter (dₐ, d_{b}) mainly based on the characteristics of the input point clouds. Parameter dₐ may be empirically selected, e.g., dₐ=7. It may be selected by checking the number of occupied voxels at a bit level, e.g., when the number starts to go beyond a pre-defined threshold. To select d_{b}, the voxel density (the density of occupied voxels) is checked. The voxel density increasing ratio from a previous bit level is computed. When the ratio starts to fall below a threshold, the current level is set to d_{b}. Basically, the remaining bits from level d_{b} will mainly contribute to increasing point precisions while the point density is not increasing. The parameter selection of (dₐ, d_{b}) typically ensures that there are enough neighboring voxels to perform meaningful convolution computation for the levels between dₐ and d_{b}-1. Additionally, the “DB” block may also take some configuration parameters as input to jointly decide the parameters (dₐ, d_{b}). For example, the configuration parameter may define the rate point that the codec operates. Typically, a higher bitrate will lead to higher values for dₐ and d_{b}.

The particular design of the “PN” (420), “VN” (430), and “ON” (440) blocks may vary from the provided examples, but they are proposed to take care of three different bit levels. The “PN” block (420) is dedicated to code the last few bits, i.e., between D−1 and d_{b}. Because the points at this range are very sparse, the “PN” block is proposed to use a point-based feature extraction that is, for example, mainly based on MLP network layers. The “VN” block (430) instead is used to code the bits between d_{b}−1 and dₐ. It is proposed to use a voxel-based feature extraction module. The “ON” block is designed to code the first dₐ bits between dₐ−1 and 0. For example, it is proposed to use a tree-based coding for geometry information and employ an arithmetic coding for the associated features. The three blocks correspond to three coding modes suitable for different bit levels. In the follows, we present some example implementations of the three blocks.

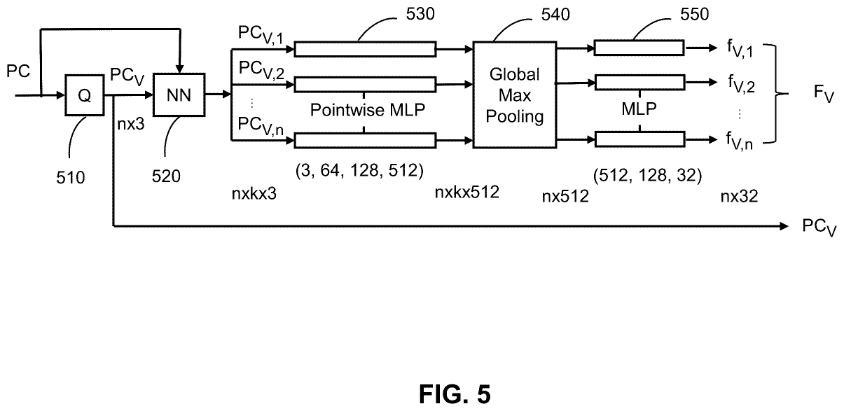

The “PN” block is a point-based feature extraction module (coding module), that would process the bits between D−1 and d_{b}. An example design of “PN” block is shown in FIG. 5, where it is mainly composed of a few MLP layers. For an input point cloud PC, it is first quantized (510) by quantization step Q, to output a point cloud PC_{V} with a bit depth of (d_{b}−1) bits and n points. Then a nearest neighbor module NN (520) looks for the k nearest neighbors of each point in PC_{V} from PC, and form n point sets, PC_{V,1}, PC_{V,2}, . . . , PC_{V},n, for each of the n points in PC_{V}. These n point sets are then fed to a series of pointwise MLP layers (530) to extract pointwise features, followed by global max pooling (540) and another series of MLP layers (550) to extract the point-based features, F_{V}={f_{V,1}, f_{V,2}, . . . , f_{V},n}, for each point in PC_{V}. The number of points in point cloud PC_{V} may be very close to the number of points in the input point cloud PC for point clouds captured from LiDAR sensors. In fact, the similar number of points is due to the high sparsity in the last few bits of such point clouds. Both point cloud PC_{V} and features F_{V} are output (F_{V} can be considered as attributes for points in PC_{V}). Note that PC_{V} represents the input point cloud PC at a reduced precision (bit depth 0 to d_{b}−1), and F_{V} are features representing detailed information at bit depth d_{b} to D−1. Namely, each point in the output PC_{V} is now associated with a point-based feature extracted by the neural network module “PN”. With the PN module, the details from the original input PC are now represented as pointwise features of PC_{V}. Hence, although PC_{V} is a quantized point cloud, it contains the detailed information from PC in associated features (F_{V}).

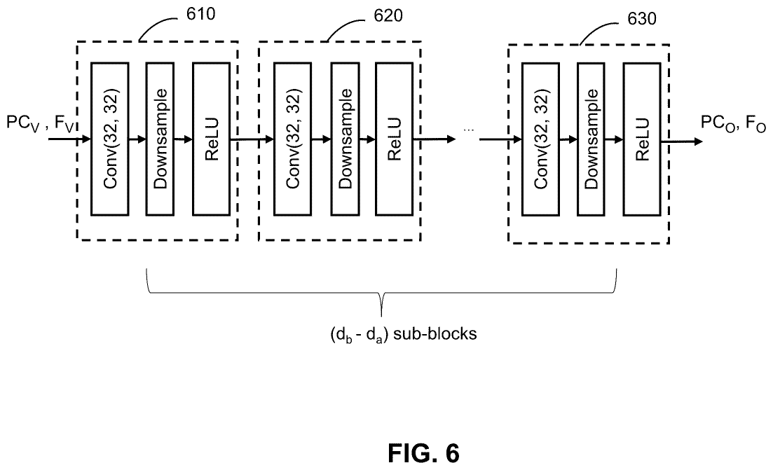

PC_{V} is then fed to the “VN” block (430) as input. Unlike the “PN” block that operates on a point-based representation, the “VN” block operates on voxels, and therefore PC_{V} is converted to be represented in the voxel grid, with a corresponding feature in F_{V} associated with the voxel as an attribute. The “VN” block employs regular convolutions or sparse convolutions as the processing backbone. An example design of “VN” block is shown in FIG. 6. It is composed of a few sub-blocks (610, 620, 630), where each sub-block (610, 620, 630) consists of a convolution layer for feature extraction, a downsampling function, and a ReLU activation function.

Note that, in this example, the downsampling ratio of each downsampling function is set to be ½. Note that each downsampling reduces the spatial resolution by half, which effectively reduces the bit depth by 1. The sub-block can use other types of activation functions, such as logistic sigmoid and tanh. The convolution layer size (the kernel size and the number of output channels) can also be different.

Since the “VN” block intends to code the bit depth from dₐ to d_{b}, the number of sub-blocks is determined by the difference (d_{b}-dₐ). Each sub-block also outputs more abstract features for the downsampled point clouds. In the end, the “VN” block outputs a point cloud PC_{O} at a lower resolution and a set of abstract features F_{O}. These features are associated with each point in PC_{O}. PC_{O} can be viewed as a more abstract version of PC_{V} at a reduced spatial resolution, and PC_{O} is sparser than PC_{V}. Moreover, PC_{O} has a set of features F_{O} associated to each of its points. As a coarse version of the input point cloud PC, PC_{O} only has a bit depth of dₐ bits.

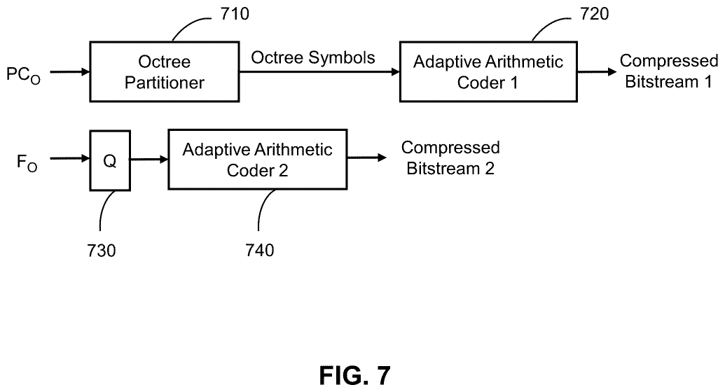

PC_{O} is then supplied to the “ON” block (440) as input. An example of “ON” block is shown in FIG. 7. The geometry positions of PC_{O} are coded into a bitstream using an octree-based encoder or another tree-based point cloud encoder in a lossless manner. In one implementation, the “ON” block uses an adaptive arithmetic coder (720) to encode the octree node symbols generated by an octree partitioner (710). In another embodiment, it may utilize a deep entropy model to boost the arithmetic coding efficiency of the octree coding. In yet another embodiment, a different tree structure may be applied, for example, QTBT tree (quarter tree and binary tree) or KD tree, etc. Additionally, the features F_{O} associated with PC_{O} are quantized (730), then also coded into the bitstream with another adaptive arithmetic coder (740). In one embodiment, the encoding of F_{O} can be boosted by utilizing a factorized prior model or a hyper-prior model. In FIG. 7, two bitstreams are generated. It should be noted that these two bitstreams can be multiplexed into one bitstream.

### Decoding

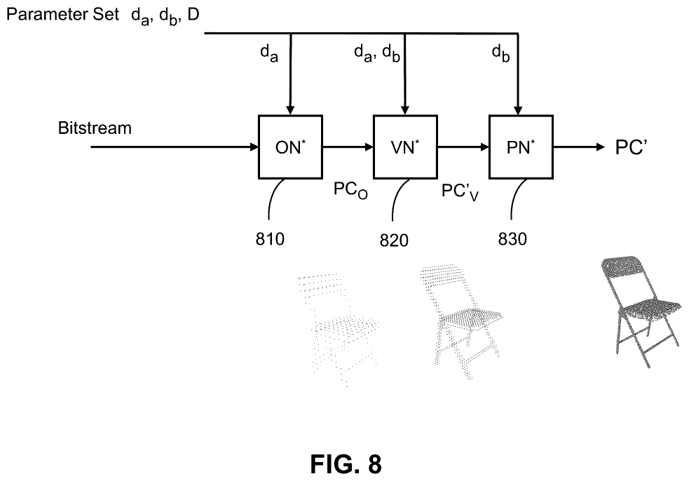

A proposed decoding procedure is shown in FIG. 8, according to an embodiment. It is an inverse procedure of the encoding. Corresponding to the encoder, the decoder obtains a parameter set that includes the total number of bits D and bit partitioning positions dₐ, and do. Then the decoder configures the decoder's network according to the total number of bits D and the bit partitioning positions dₐ, and d_{b}, then invokes the decoding process in the sequential order:
Decoding a coarse point cloud, PC_{O}, and its associated point-wise features using a tree-based decoding block;
Upsampling the coarse point cloud to a denser point cloud, PC′_{V} and updating the point-wise features using a voxel-based decoding block; and
Refining the precision of the coordinates of the dense but low bit depth point cloud (PC′_{V}) to high bit depth point cloud, PC′, using a point-based decoding block.

More generally, the point cloud PC_{O} can be viewed as a first reconstructed version of the point cloud, the point cloud PC′_{V} can be viewed as a second reconstructed version of the point cloud, and the point cloud PC′ can be viewed as a third reconstructed version of the point cloud. From the first version PC_{O} to the second version PC′_{V}, the points get denser, and from the second version PC′_{V} to the third version PC′, the precision of the coordinates of the point cloud gets refined.

In this embodiment, the proposed decoder first receives the parameter set to configure the decoding procedure according to the parameter (dₐ, d_{b}) and the total bit depth D. The decoding process then proceeds according to the parsed parameters.

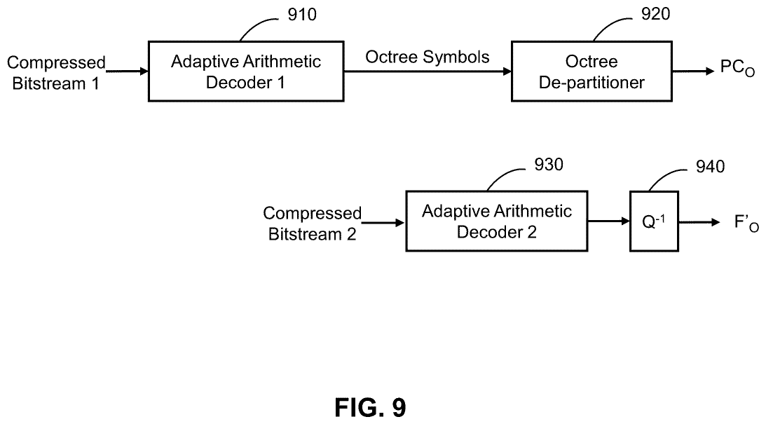

First, block “ON*” (810) uses tree-based decoding to reconstruct first dₐ bits that is a coarse reconstruction of point cloud, PC_{O}. FIG. 9 shows an example design of block “ON*”. An entropy decoder (910) and an octree de-partitioner (920) are used to reconstructed PC_{O}. “ON*” also decodes the set of point-wise feature F′_{O} for each point in PC_{O}, by an entropy decoder (930) and a de-quantizer (940).

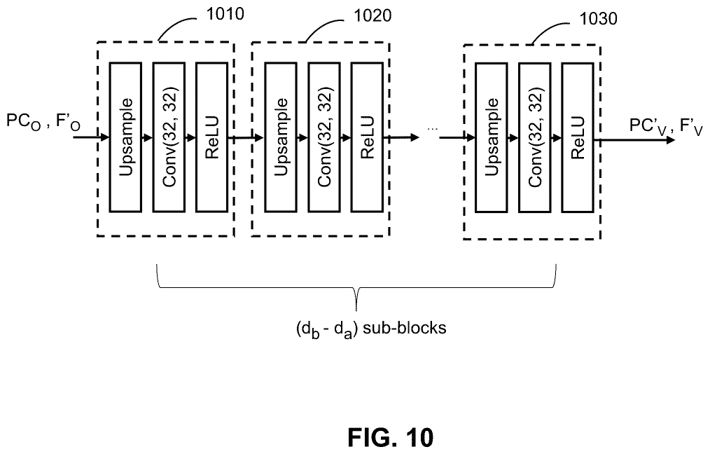

PC_{O} and the feature F′_{O} are then fed as input to the next block “VN*” (820). The structure of block “VN*” is configured based on the parameter (dₐ, d_{b}). FIG. 10 shows an example design of block “VN*”. Same as the encoder side, there are (d_{b}-dₐ) sub-blocks (1010, 1020, 1030) in block “VN*”, where each sub-block (1010, 1020, 1030) performs upsampling, voxel-based convolution, and an ReLU activation function to progressively obtain the point cloud PC′_{V} (the reconstruction of PC_{V}) from PC_{O}. In this example, the upsampling ratio of the upsampling function is set to 2. Note that the features F′_{V} associated with each point of PC′_{V} are also outputted by VN*. In one embodiment, the “VN*” may utilize a sparse convolution.

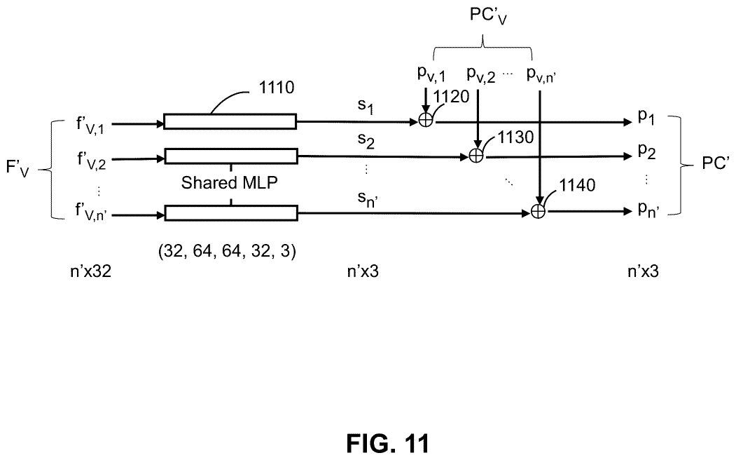

PC′_{V} is finally sent to block “PN*” (830) to reconstruct the last few bits from d_{b} to D−1 to obtain the final reconstructed point cloud PC′. The block “PN*” is proposed to utilize point-based architectures. FIG. 11 shows an example design of block “PN*”. In one embodiment, it could be implemented by a LatentGAN network or a few MLP layers to refine the point's precision. Suppose PC′_{V} has n′ points, then the MLP layers (1110) take the features F′_{V} as input, then output a set of offset coordinates, {s₁, s₂, . . . , sₙ′}, each corresponds to one point in PC′_{V}. By adding up (1120, 1130, 1140) the offset coordinates with the associated points in PC′_{V}, a reconstructed point cloud PC′ with n′ points is obtained. In another embodiment, the MLP layers may be configured to output two or more offset points for each point in PC′_{V}. Then by adding up all the offsets with the associated points in PC′_{V}, a reconstructed point cloud PC′ with more than n′ points can be obtained. In this case, the reconstructed point cloud PC′ not only has higher precision than PC′_{V}, but also is denser than PC′_{V}.

### Generalized Hybrid Coding Framework

In the above, we described a hybrid coding framework based on three different ranges of bit levels. In the follows, we present some extended hybrid coding frameworks.

### Spatially Gradual Coding

In one embodiment, we propose to generalize the three sets of bit levels to three spatial resolutions. Each spatial resolution corresponds to a different quantization step on the input point cloud.

Suppose the input point cloud is still represented by a D-bit integer number. The dₐ and d_{b} bit level used earlier corresponds to two quantization steps Qₐ=pow (2, D-dₐ−1) and Q_{b}=pow (2, D-d_{b}−1), respectively. With the generalized hybrid coding framework, Qₐ and Q_{b} could be selected with more flexibility and not necessarily to be a power of 2.

### Reduced Hybrid Coding

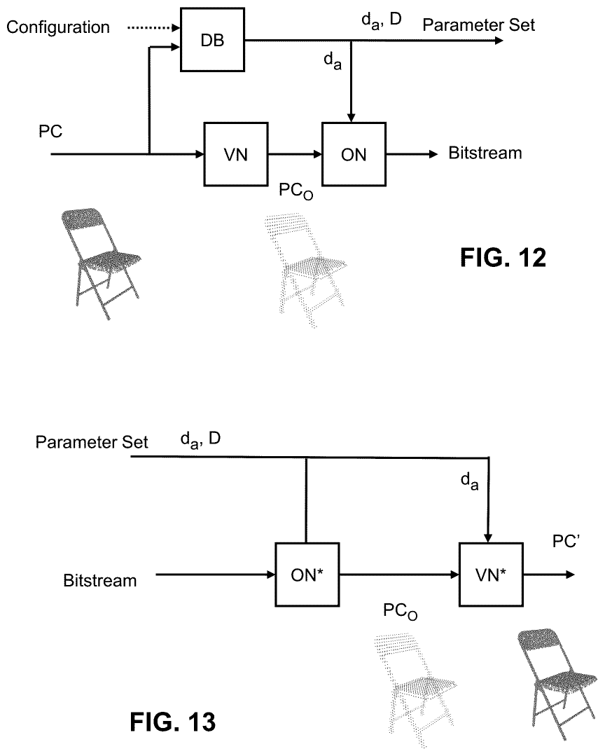

In one embodiment, it is not necessarily to include all the three coding modules. Instead, it may only have two coding modules. For example, if the target point cloud is quite dense, we may only need the “ON” block and “VN” block as illustrated in FIG. 12. When the VN block as illustrated in FIG. 6 is used, F_{V} can be assumed to be filled with 1s. In this case, the decoder only needs to be signaled with two parameters dₐ and D, as illustrated in FIG. 13. On the other hand, when the target point cloud is sparse, we may only use the “ON” block and the “PN” block where the “PN” block is especially effective to handle the sparsity nature of the input point cloud. Similarly, in this case, the decoder only needs to be signaled with two parameters dₐ and D.

### Complexity Scalable Decoding

When the bitstream is provided to the decoder, the decoder could decide at which step to stop the decoding process. An early stopping of the decoding will lead to a coarser point cloud but consume less computational cost for the decoding.

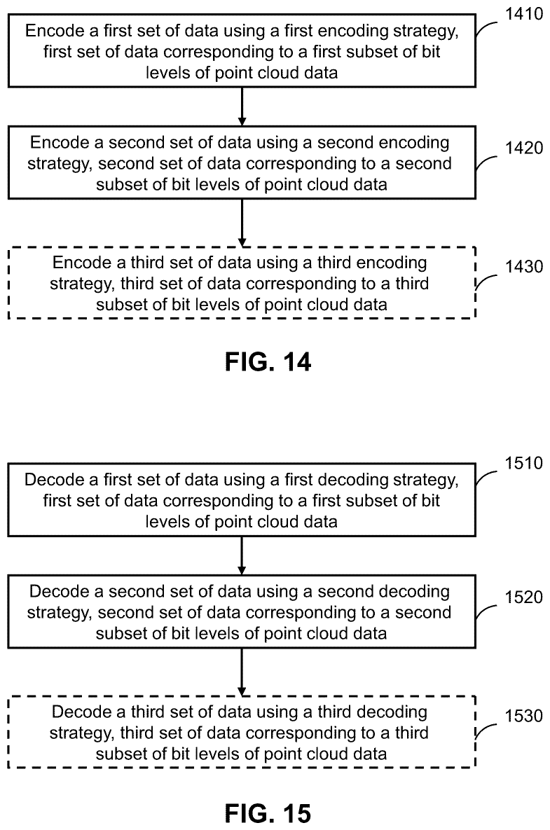

FIG. 14 illustrates a method of encoding point cloud data, according to an embodiment. In this embodiment, for a point cloud or a portion of point cloud to be encoded, the encoder encodes (1410) a first set of data using a first encoding strategy, where the first set of data corresponds to a first subset of bit levels of point cloud data. The encoder then encodes (1420) a second set of data using a second encoding strategy, where the second set of data corresponding to a second subset of bit levels of point cloud data. The point cloud can be encoded with just two sets of data, where the first set of data contains the most significant bits and the second set of data contains the rest of the bits. The first and second encoding strategy can be octree-based encoding and point-based network, respectively.

The encoder can divide the point cloud to more sets of data. When the point cloud data is divided into three data sets, the first set of data contains the most significant bits, the third set of data contains the least significant bits, and the second set of data contains the rest of the bits. The encoder encodes (1430) the third set of data using a third encoding strategy. As described before, the first, second and third encoding strategy can be octree-based encoding, voxel-based encoding and point-based network, respectively.

FIG. 15 illustrates a method of decoding point cloud data, according to an embodiment. In this embodiment, for a point cloud or a portion of point cloud to be decoded, the decoder decodes (1510) a first set of data using a first decoding strategy, where the first set of data corresponds to a first subset of bit levels of point cloud data. The decoder then decodes (1520) a second set of data using a second decoding strategy, where the second set of data corresponding to a second subset of bit levels of point cloud data. The point cloud can just consist of two sets of data, where the first set of data contains the most significant bits and the second set of data contains the rest of the bits. The first and second decoding strategy can be octree-based decoding and point-based network, respectively.

The point cloud can contain more sets of data. When the point cloud data is divided into three portions, the first set of data contains the most significant bits, the third set of data contains the least significant bits, and the second set of data contains the rest of the bits. The decoder decodes (1530) the third set of data using a third decoding strategy. As described before, the first, second and third decoding strategy can be octree-based decoding, voxel-based decoding and point-based network, respectively.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed 20) options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of decoding point cloud data for a point cloud, comprising:
decoding a first set of data using a first decoding strategy, wherein said first set of data corresponds to a first subset of bit levels of point coordinates of said point cloud data; and
decoding a second set of data using a second decoding strategy, wherein said second set of data corresponds to a second subset of bit levels of point coordinates of said point cloud data.

2. (canceled)

3. The method of claim 1, wherein said first subset of bit levels are bit levels 0 to dₐ−1 and said second subset of bit levels are bit levels dₐ to d_{b}−1, wherein bit 0 represents the most significant bit, dₐ and d_{b} are integers, and dₐ<d_{b}.

4. (canceled)

5. The method of claim 1, wherein said first decoding strategy is a lossless decoding strategy.

6. The method of claim 1, wherein said second decoding strategy is a voxel-based decoding strategy or a point-based decoding strategy.

7. The method of claim 6, wherein said voxel-based decoding strategy comprises:
a plurality of sub-blocks, wherein each sub-block of said plurality of sub-blocks includes an upsampling function, a convolution layer, and an activation function, and wherein a number of sub-blocks in said plurality of sub-blocks is the same as a number of bit levels in said second subset of bit levels.

8-18. (canceled)

19. A method of encoding point cloud data for a point cloud, comprising:
encoding a first set of data using a first encoding strategy, wherein said first set of data corresponds to a first subset of bit levels of point coordinates of said point cloud data; and
encoding a second set of data using a second encoding strategy, wherein said second set of data corresponds to a second subset of bit levels of point coordinates of said point cloud data.

20. (canceled)

21. The method of claim 19, wherein said first subset of bit levels are bit levels 0 to dₐ−1 and said second subset of bit levels are bit levels dₐ to d_{b}−1, wherein bit 0 represents the most significant bit, dₐ and d_{b} are integers, and dₐ<d_{b}.

22. The method of claim 21, wherein a value of dₐ is chosen based on at least one of a number of occupied voxels at a bit level and a configuration parameter.

23-24. (canceled)

25. The method of claim 19, wherein said first encoding strategy is a lossless encoding strategy.

26. The method of claim 19, wherein said second encoding strategy is a voxel-based encoding strategy.

27-38. (canceled)

39. An apparatus for decoding point cloud data for a point cloud, comprising one or more processors and at least one memory coupled to said one or more processors, wherein said one or more processors are configured to:
decode a first set of data using a first decoding strategy, wherein said first set of data corresponds to a first subset of bit levels of point coordinates of said point cloud data; and
decode a second set of data using a second decoding strategy, wherein said second set of data corresponds to a second subset of bit levels of point coordinates of said point cloud data.

40. The apparatus of claim 39, wherein said first subset of bit levels are bit levels 0 to dₐ−1 and said second subset of bit levels are bit levels dₐ to d_{b}−1, wherein bit 0 represents the most significant bit, dₐ and d_{b} are integers, and dₐ<d_{b}.

41. The apparatus of claim 39, wherein said first decoding strategy is a lossless decoding strategy.

42. The apparatus of claim 39, wherein said second decoding strategy is a voxel-based decoding strategy or a point-based decoding strategy.

43. The apparatus of claim 42, wherein said voxel-based decoding strategy comprises:
a plurality of sub-blocks, wherein each sub-block of said plurality of sub-blocks includes an upsampling function, a convolution layer, and an activation function, and wherein a number of sub-blocks in said plurality of sub-blocks is the same as a number of bit levels in said second subset of bit levels.

44. An apparatus for encoding point cloud data for a point cloud, comprising one or more processors and at least one memory coupled to said one or more processors, wherein said one or more processors are configured to:
encode a first set of data using a first encoding strategy, wherein said first set of data corresponds to a first subset of bit levels of point coordinates of said point cloud data; and
encode a second set of data using a second encoding strategy, wherein said second set of data corresponds to a second subset of bit levels of point coordinates of said point cloud data.

45. The apparatus of claim 44, wherein said first subset of bit levels are bit levels 0 to dₐ−1 and said second subset of bit levels are bit levels dₐ to d_{b}−1, wherein bit 0 represents the most significant bit, dₐ and d_{b} are integers, and dₐ<d_{b}.

46. The apparatus of claim 45, wherein a value of dₐ is chosen based on at least one of a number of occupied voxels at a bit level and a configuration parameter.

47. The apparatus of claim 44, wherein said first encoding strategy is a lossless encoding strategy.

48. The apparatus of claim 44, wherein said second encoding strategy is a voxel-based encoding strategy.
